(19) United States
(12) Patent Application Publication
(10) Pub. No.: US 2026/0365296 A1
(43) Pub. Date: Nov. 19, 2026

(54) REMOTE CONTROL DEVICE

(71) Applicant: ASAHI DENSO CO., LTD., Hamamatsu City (JP)

(72) Inventor: Yohei MIMURA, Shizuoka (JP)

(21) Appl. No.: 19/677,022

(22) Filed: May 14, 2026

(30) Foreign Application Priority Data
May 16, 2025 (JP) 2025-082695

(51) Int. Cl. B63H 25/02; B63H 21/00; B63H 21/21

(52) U.S. Cl. CPC B63H 25/02; B63H 21/21; B63H 21/24; B63H 2021/216; B63H 2025/026; B63H 2025/028

(57) ABSTRACT

A remote control device is used for operating a vehicle by remote control. The remote control device includes a body case configured to be gripped by an operator, a plurality of operation units each configured to be operated at a predetermined position of the body case and formed with a magnet, a plurality of magnetic sensors each corresponding to the respective operation unit, provided in the body case and configured to detect a magnetic change of the magnet formed in the operation unit to detect an operation, and a substrate to which the magnetic sensors are attached. The magnetic sensors attached to the substrate are arranged at positions different in level from each other in the body case.

### CROSS-REFERENCE TO RELATED APPLICATIONS

This application is based on and claims priority under 35 USC 119 from Japanese Patent Application No. 2025-082695 filed on May 16, 2025, the entire content of which is incorporated herein by reference.

### TECHNICAL FIELD

The present disclosure relates to a remote control device for operating a vehicle by remote control.

### BACKGROUND ART

US2005/0126468A discloses a remote control device for wirelessly operating an outboard motor mounted on a small ship or the like by remote control. The remote control device is configured to include a body case that can be gripped by an operator and a plurality of operation units that are attached to the body case and can be arbitrarily operated. The outboard motor can be operated by extending and operating a thumb, an index finger, or the like of the operator gripping the body case to any operation unit.

The present applicant has studied a remote control device in which magnets are formed in a plurality of operation units respectively, magnetic sensors corresponding to the operation units are arranged in a body case, and the magnetic sensors detect magnetic changes of the magnets caused by the operation of the operation units to detect the operation. However, it has been found that there is the following problem in the remote control device.

It is important to reduce a size and a weight of the remote control device that is gripped and operated by one hand, and the operation units are required to facilitate complicated operations. However, when the operation units and the magnetic sensors are collectively arranged, there is a possibility that the magnetism of each magnet formed in the operation unit interferes with each other. Therefore, since it is necessary for the remote control device in the prior art to provide a magnetic shielding member for suppressing magnetic interference, the remote control device becomes large and heavy.

Since the problem occurs not only in a remote control device applied to an outboard motor of a small ship but also in a remote control device that remotely operates a vehicle including a general vehicle such as an automobile or a two-wheeled vehicle or a special vehicle such as a farm machine, the applicant has intensively studied to solve the problem also in a remote control device of a general vehicle.

### SUMMARY OF INVENTION

An object of the present disclosure is to provide a remote control device capable of maintaining operability of operation units and reducing a size and a weight of the remote control device while suppressing magnetic interference of magnets formed in the operation units.

A first aspect of the present disclosure relates to a remote control device for operating a vehicle by remote control, the remote control device having:
a body case configured to be gripped by an operator;
a plurality of operation units each configured to be operated at a predetermined position of the body case and formed with a magnet;
a plurality of magnetic sensors each corresponding to the respective operation unit, provided in the body case and configured to detect a magnetic change of the magnet formed in the operation unit to detect an operation; and
a substrate to which the magnetic sensors are attached, in which
the magnetic sensors attached to the substrate are arranged at positions different in level from each other in the body case.

In a second aspect of the present disclosure, the magnets formed in the operation units are attached to the operation units such that magnetic lines of force of the magnets are in directions different from each other in a state where the operation units are in initial positions.

In a third aspect of the present disclosure, the operation unit includes a first operation unit and a second operation unit arranged at positions close to each other,
the substrate includes:
   a first substrate to which a first magnetic sensor configured to detect a magnetic change of a magnet formed in the first operation unit to detect an operation of the first operation unit is attached; and
   a second substrate to which a second magnetic sensor configured to detect a magnetic change of a magnet formed in the second operation unit to detect an operation of the second operation unit is attached, and
the first magnetic sensor and the second magnetic sensor attached to the first substrate and the second substrate are arranged at positions different in level from each other in the body case.

In a fourth aspect of the present disclosure, the remote control device includes:
a case member in which the first substrate is attached to one attachment surface of the case member, and the second substrate is attached to an other attachment surface of the case member, in which
the first magnetic sensor and the second magnetic sensor on the first substrate and the second substrate attached to the case member are different in level from each other.

In a fifth aspect of the present disclosure, the first operation unit is positioned on an upper surface of a tip end portion of the body case, and the second operation unit is positioned on an end surface of the tip end portion of the body case.

In a sixth aspect of the present disclosure, the first operation unit is a joystick having an operation lever configured to be swung in at least four directions orthogonal to each other from an initial position.

In a seventh aspect of the present disclosure, the vehicle is a ship, and an outboard motor of the ship is configured to be operated by the operation unit under remote control.

According to the first aspect of the present disclosure, the remote control device includes the body case, the plurality of operation units, the plurality of magnetic sensors, and the substrate, and the magnetic sensors attached to the substrate are arranged at positions different in level from each other in the body case. Therefore, the operability of the operation units can be maintained, and the size and the weight of the remote control device can be reduced while suppressing the magnetic interference of the magnets formed in the operation units.

According to the second aspect of the present disclosure, the magnets formed in the operation units are attached to the operation units such that the magnetic lines of force of the magnets are in directions different from each other in the state where the operation units are in the initial positions. Therefore, it is possible to more reliably suppress the magnetic interference of the magnets formed in the operation units, and to further reduce the size and the weight of the remote control device.

According to the third aspect of the present disclosure, the substrate includes the first substrate to which the first magnetic sensor configured to detect the magnetic change of the magnet formed in the first operation unit to detect the operation of the first operation unit is attached, and the second substrate to which the second magnetic sensor configured to detect the magnetic change of the magnet formed in the second operation unit to detect the operation of the second operation unit is attached, and the first magnetic sensor and the second magnetic sensor attached to the first substrate and the second substrate are arranged at positions different in level from each other in the body case. Therefore, it is possible to maintain the operability of the first operation unit and the second operation unit, and to achieve miniaturization and weight reduction while suppressing the magnetic interference of the magnets formed in the first operation unit and the second operation unit.

According to the fourth aspect of the present disclosure, the case member is provided in which the first substrate is attached to one attachment surface of the case member, and the second substrate is attached to the other attachment surface of the case member, and the first magnetic sensor and the second magnetic sensor of the first substrate and the second substrate attached to the case member are different in level from each other. Therefore, the first magnetic sensor of the first substrate and the second magnetic sensor of the second substrate can be reliably arranged in different levels using the case member.

According to the fifth aspect of the present disclosure, the first operation unit is positioned on the upper surface of the tip end portion of the body case, and the second operation unit is positioned on the end surface of the tip end portion of the body case. Therefore, the second operation unit can be operated with the index finger while the first operation unit is operated with the thumb of the operator holding the body case, and the operability can be improved.

According to the sixth aspect of the present disclosure, the first operation unit is a joystick having an operation lever configured to be swung in at least four directions orthogonal to each other from the initial position. Therefore, the operation by the joystick can be easily performed.

According to the seventh aspect of the present disclosure, the vehicle is the ship, and the outboard motor of the ship is configured to be operated by the operation unit under remote control. Therefore, the ship can be easily operated by the remote control device under the remote control.

### BRIEF DESCRIPTION OF DRAWINGS

Exemplary embodiment(s) of the present invention will be described in detail based on the following figures, wherein:

FIG. 1 is a perspective view showing an overall appearance of a remote control device according to an embodiment of the present disclosure;

FIG. 2 is a three-sided view showing the remote control device;

FIG. 3 is a cross-sectional view taken along a line III-III in FIG. 2;

FIG. 4 is a cross-sectional view taken along a line IV-IV in FIG. 2;

FIG. 5 is a cross-sectional view taken along a line V-V in FIG. 2;

FIG. 6 is an exploded perspective view showing an internal configuration of the remote control device;

FIG. 7 is an exploded perspective view showing an internal configuration of the tip end portion of the remote control device;

FIG. 8 is an exploded perspective view showing the internal configuration of the tip end portion of the remote control device;

FIGS. 9A and 9B are perspective views showing an appearance of the tip end portion of the remote control device;

FIGS. 10A and 10B are longitudinal cross-sectional views for explaining operation of a first operation unit in the remote control device;

FIGS. 11A and 11B are cross-sectional views for explaining operation of the first operation unit in the remote control device;

FIG. 12 is an exploded perspective view showing an attachment structure of the first operation unit, a second operation unit, a second substrate, a first accommodation case, and a second accommodation case to a case member in the remote control device;

FIG. 13 is an exploded perspective view showing an attachment structure of the first operation unit, the second operation unit, a first substrate, the first accommodation case, and the second accommodation case to the case member in the remote control device;

FIG. 14 is a two-side view showing an attachment structure of the first operation unit, the second operation unit, the first substrate, the second substrate, and a connector member in the remote control device;

FIG. 15 is a perspective view showing an attachment structure of the first operation unit, the second operation unit, the first substrate, and the second substrate in the remote control device;

FIG. 16 is a perspective view showing an attachment structure of the first operation unit, the second operation unit, the first substrate, and the second substrate in the remote control device;

FIG. 17 is a three-sided view showing the case member in the remote control device;

FIGS. 18A and 18B are perspective views showing an attachment structure of the first substrate, the second substrate, and the connector member in the remote control device;

FIG. 19 is a schematic diagram showing a state where an operator holds the remote control device; and

FIG. 20 is a schematic diagram showing a ship and an outboard motor to which the remote control device is applied.

### DESCRIPTION OF EMBODIMENTS

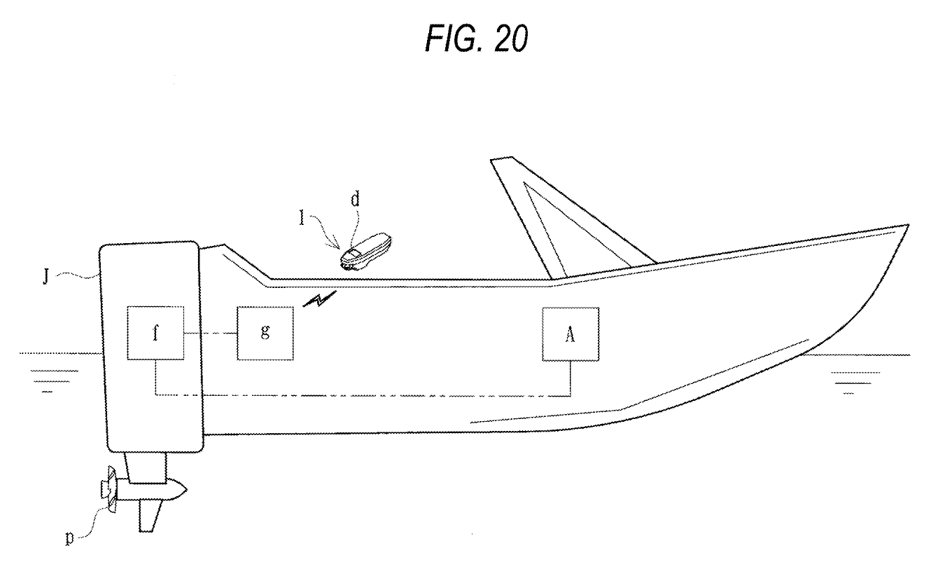

Hereinafter, an embodiment of the present disclosure will be specifically described with reference to the drawings. As shown in FIG. 20, a remote control device 1 according to the present embodiment is applied to a ship as a vehicle (particularly, a small ship including an outboard motor J) and is capable of operating the outboard motor J including a propeller p and the like by remote control. The applied ship includes, for example, a control unit f for controlling the outboard motor J, an operation portion A for operating the control unit f, and a communication unit g connected to the control unit f.

The control unit f includes a microcomputer, an arithmetic circuit, and the like for controlling the outboard motor J, and is configured to control the outboard motor J in accordance with an operation of the operation portion A by a driver so that, for example, the ship can move forward and backward and turn in the left-right direction. The communication unit g has an antenna capable of receiving a control signal wirelessly transmitted from the remote control device 1, and is configured to operate the control unit f by remote operation by the remote control device 1 to, for example, move the ship forward and backward and turn the ship in the left-right direction.

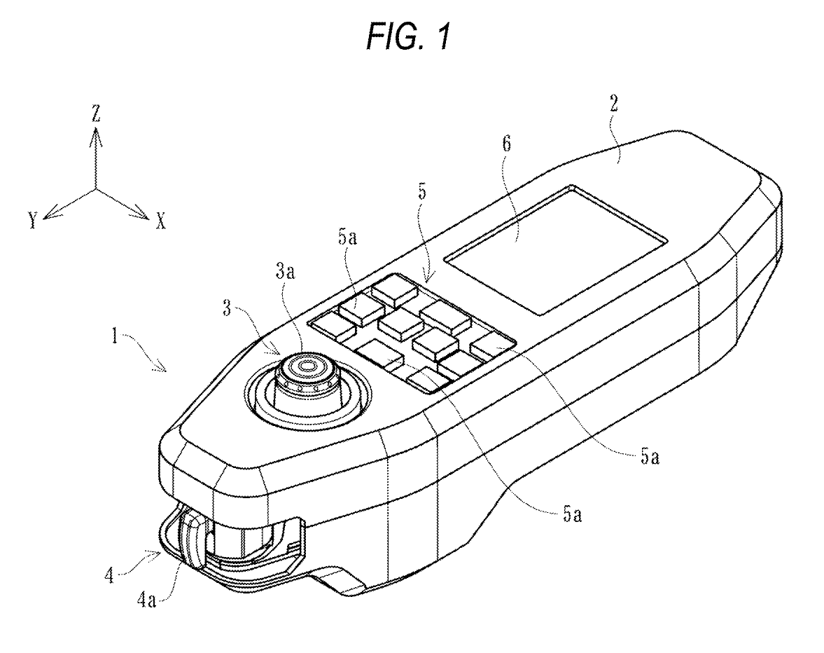

The remote control device 1 according to the present embodiment is a remote controller equipped with a communication unit d capable of wirelessly communicating with the communication unit g of the ship. As shown in FIGS. 1 - 6, the remote control device 1 according to the present embodiment includes a body case 2, a plurality of operation units (first operation unit 3 and second operation unit 4), a plurality of magnetic sensors (first magnetic sensor 8 and second magnetic sensor 10), substrates (first substrate 7 and second substrate 9), a case member 11, a connector member 12, a first accommodation case 13, and a second accommodation case 14. The width direction X, the longitudinal direction Y, and the thickness direction Z of the remote control device 1 are orthogonal directions to each other.

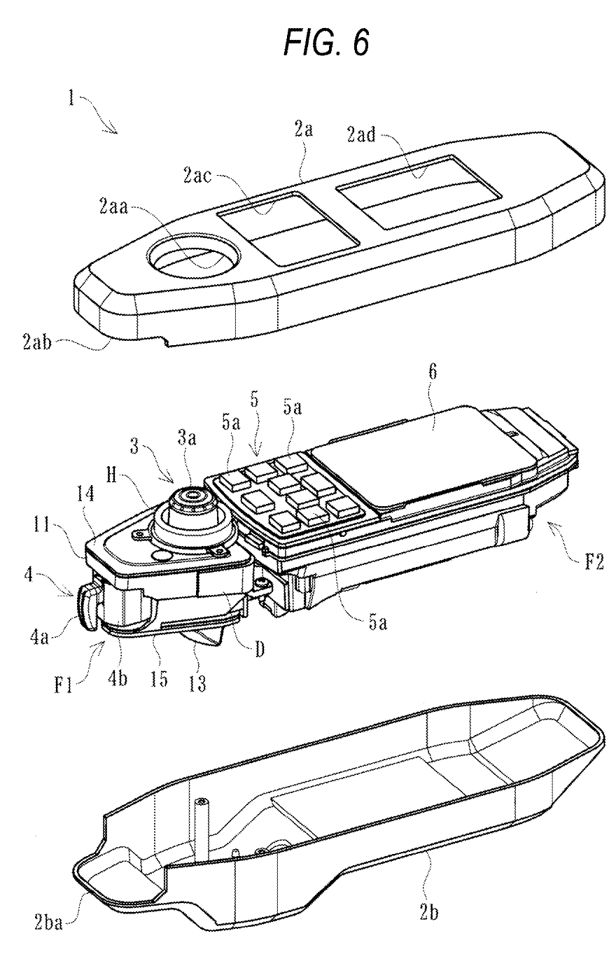

The body case 2 is formed of a resin case that can be gripped by an operator, and as shown in FIG. 6, includes a front side case 2a in which opening portions 2aa, 2ac, 2ad and a notch portion 2ab are formed, and a rear side case 2b in which a notch portion 2ba is formed, and an accommodation space is formed inside by matching the front side case 2a and the rear side case 2b. A tip end portion F1 and a body portion F2 constituting the main portion of the remote control device 1 are accommodated in the accommodation space formed by matching the front side case 2a and the rear side case 2b.

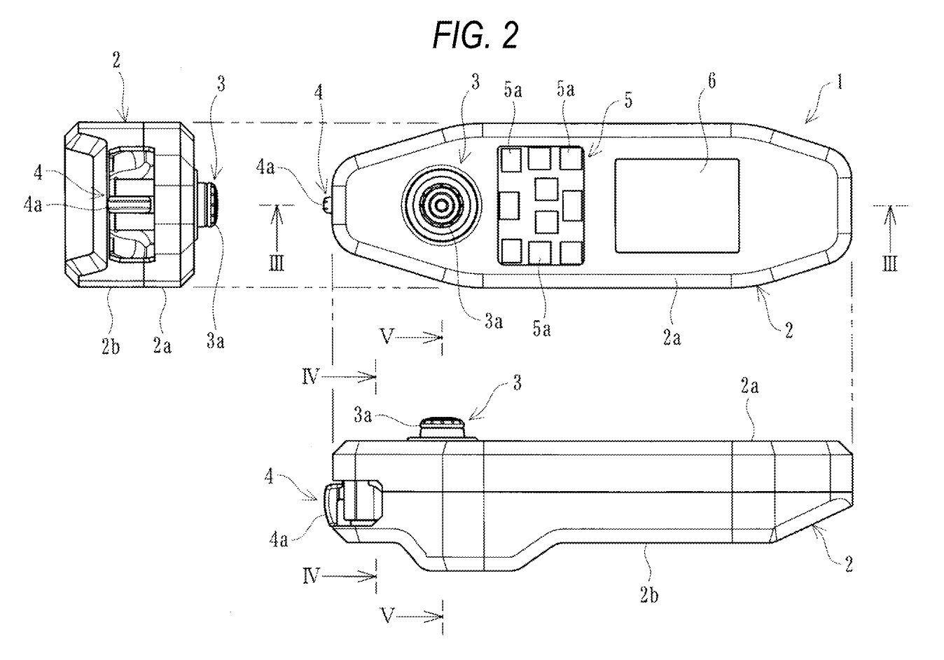

As shown in FIGS. 1 and 2, in the remote control device 1 according to the present embodiment, when the front side case 2a and the rear side case 2b are matched with each other, an operation portion 3a and the like of the first operation unit 3 protrude upward through the opening portion 2aa and can be operated. Further, in the remote control device 1 according to the present embodiment, when the front side case 2a and the rear side case 2b are aligned with each other, an operation button 5a of a third operation unit 5 is exposed to the outside through the opening portion 2ac, and a display unit 6 is exposed to the outside through the opening portion 2ad. Further, in the remote control device 1 according to the present embodiment, when the front side case 2a and the rear side case 2b are matched with each other, the notch portion 2ab of the front side case 2a and the notch portion 2ba of the rear side case 2b are matched with each other, and an operation portion 4a of the second operation unit 4 can be operated to face forward.

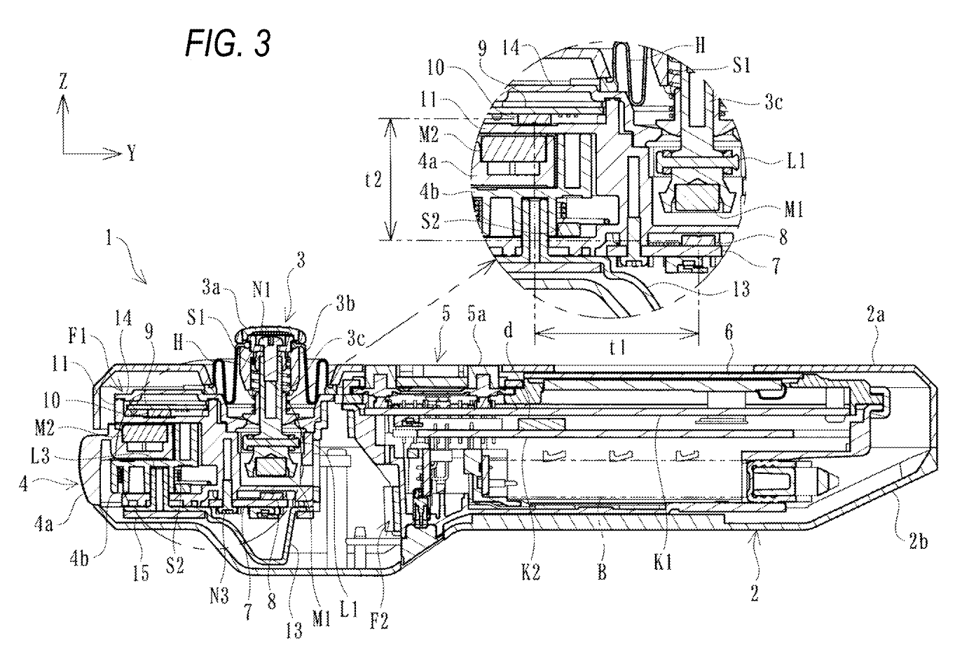

As shown in FIGS. 3 and 6, the body portion F2 includes the third operation unit 5 having a plurality of operation buttons 5a, the display unit 6 formed of a liquid crystal screen or the like, substrates K1 and K2, and a battery B. The communication unit d is formed on the substrate K1, and a signal corresponding to the operation of the operation unit such as the first operation unit 3, the second operation unit 4, and the third operation unit 5 can be wirelessly transmitted from the communication unit d to the communication unit g arranged in the ship. The battery B is a rechargeable power source, and is capable of supplying power necessary for communication by the communication unit d and display by the display unit 6.

The tip end portion F1 is connected to the body portion F2 and is electrically connected to the body portion F2 by wiring (not shown), and is configured to include the plurality of operation units (first operation unit 3 and second operation unit 4) as shown in FIGS. 2 - 9B. In the drawings, reference character "D" denotes a reinforcing member for reinforcing the tip end portion F1. The operation units according to the present embodiment include a first operation unit 3 and a second operation unit 4, each of the operation units can be operated at a predetermined position of the body case 2 and has a magnet (M1, M2).

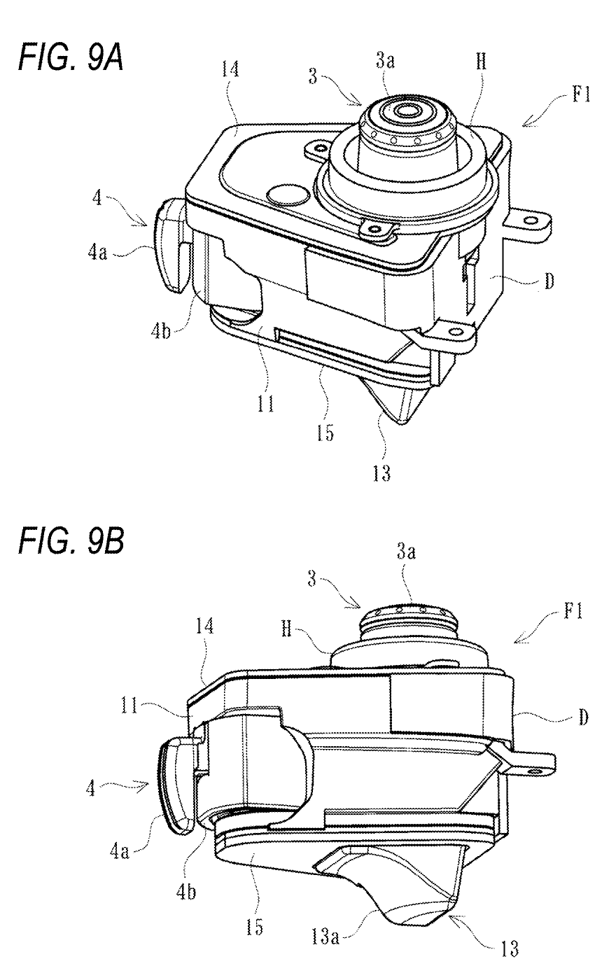

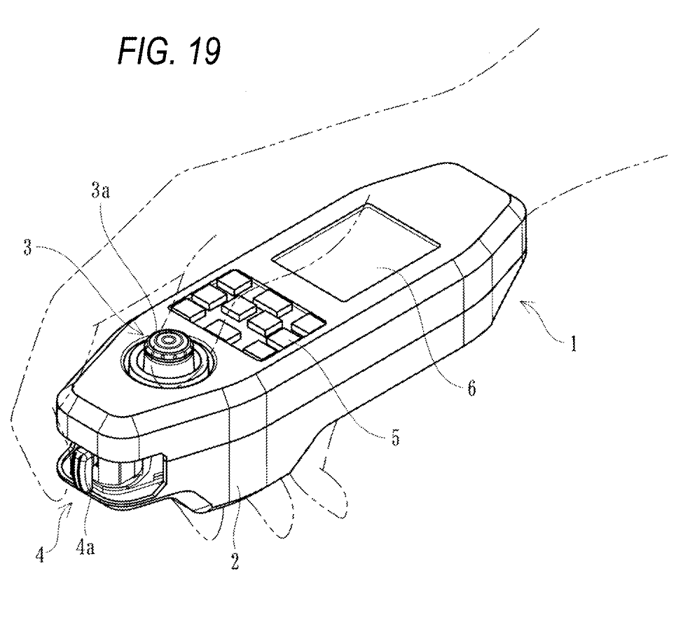

As shown in FIGS. 9A and 9B, the first operation unit 3 is positioned on the upper surface of the tip end portion F1 of the body case 2, and as shown in FIG. 19, can be operated by the thumb of the operator holding the body case 2, and includes a joystick having operation levers (a first operation lever 3b and a second operation lever 3c) that can be swung in at least four directions (in the present embodiment, the longitudinal directions Y and the width directions X of the remote control device 1) orthogonal to each other from the initial position.

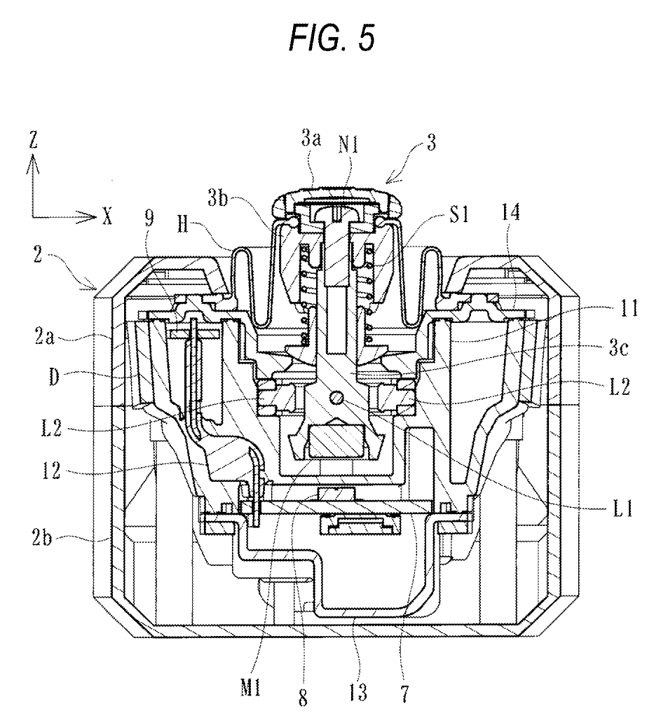

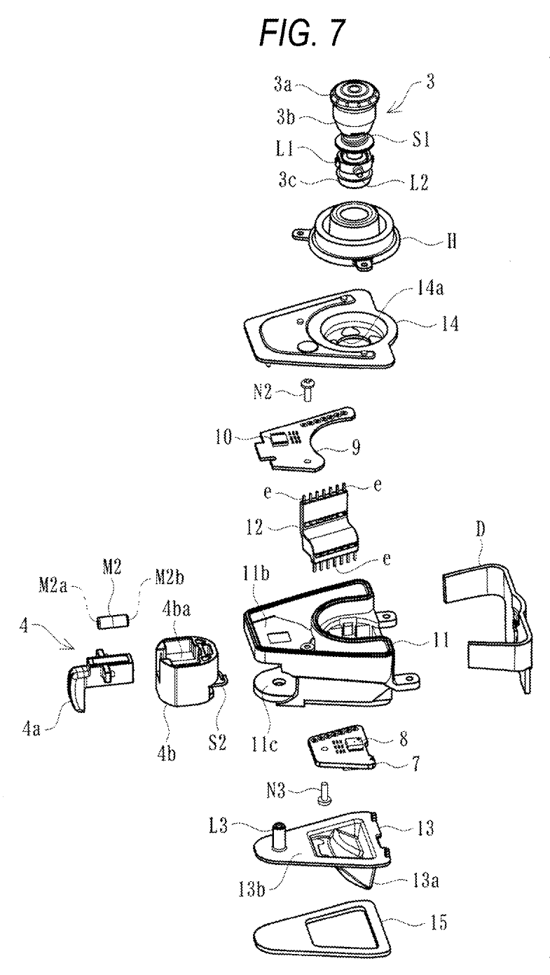

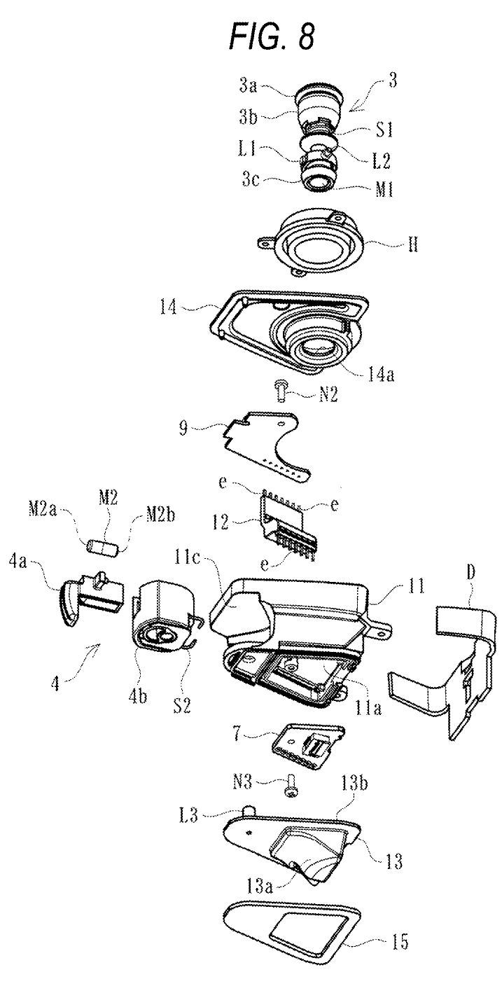

Specifically, as illustrated in FIGS. 5, 7, and 8, the first operation unit 3 includes an operation portion 3a that can be operated by an operator touching with a finger, the first operation lever 3b and the second operation lever 3c connected to the operation portion 3a with a connection screw N1, a return spring S1, and axes L1 and L2 extending in directions orthogonal to each other. A seal member H is attached between the operation portion 3a and the first operation lever 3b, and the body case 2 so as to achieve waterproofing.

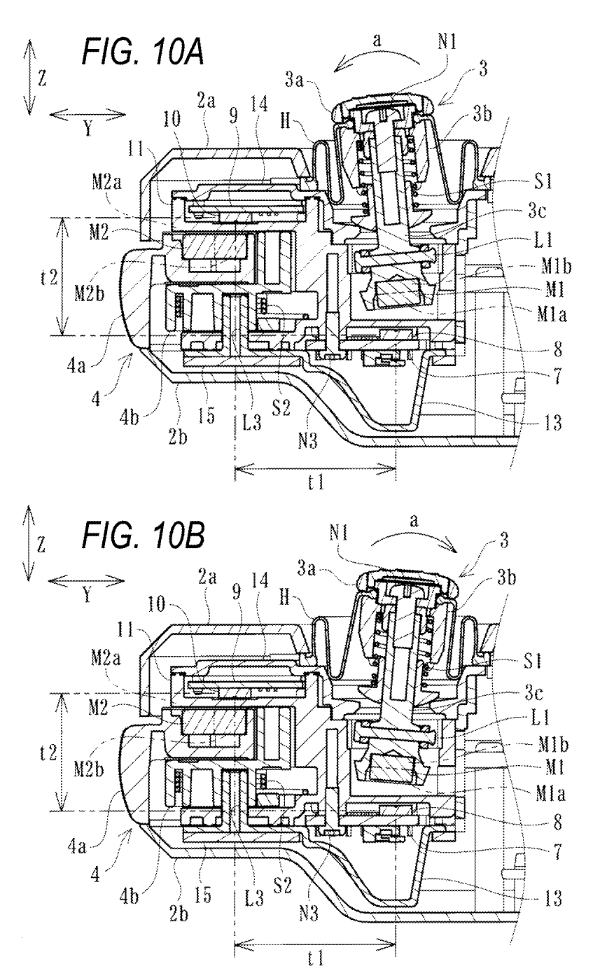

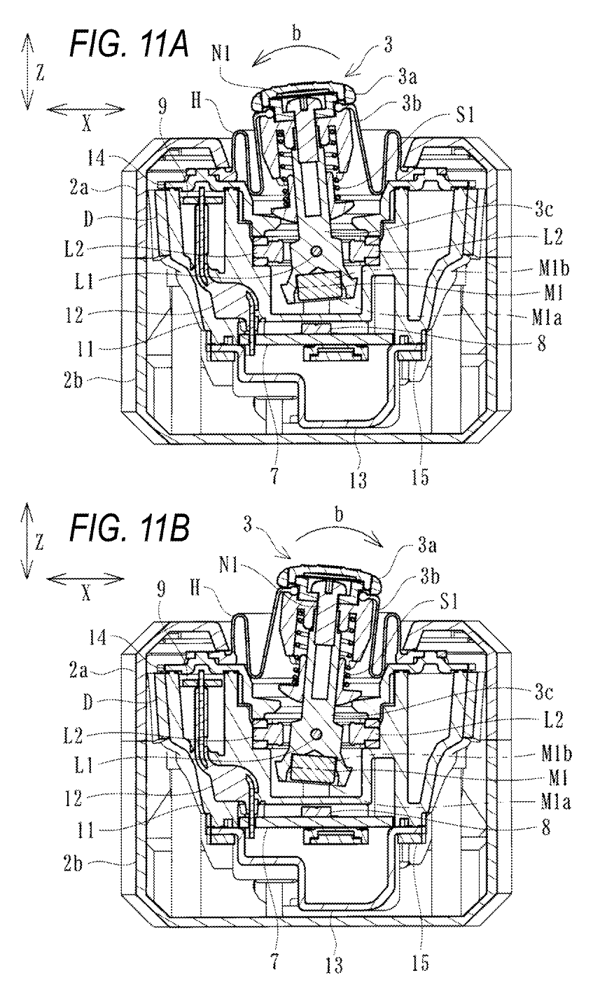

In the first operation unit 3, as shown in FIGS. 10A and 10B, when the operation portion 3a is operated in the a-direction (longitudinal direction Y of the remote control device 1), the first operation lever 3b and the second operation lever 3c swing about the axis L2 against the biasing force of the return spring S1, and as shown in FIGS. 11A and 11B, when the operation portion 3a is operated in the b-direction (width direction X of the remote control device 1), the first operation lever 3b and the second operation lever 3c swing about the axis L1 against the biasing force of the return spring S1.

A magnet M1 is attached to a tip end portion of the second operation lever 3c of the first operation unit 3. The magnet M1 has magnetic poles M1a and M1b (one is an S pole and the other is an N pole) different from each other with respect to the thickness direction Z (vertical direction) of the remote control device 1 in a state where the first operation unit 3 is at the initial position, and is integrally attached to the first operation unit 3 and is configured to integrally move in accordance with the swing operation of the first operation unit 3.

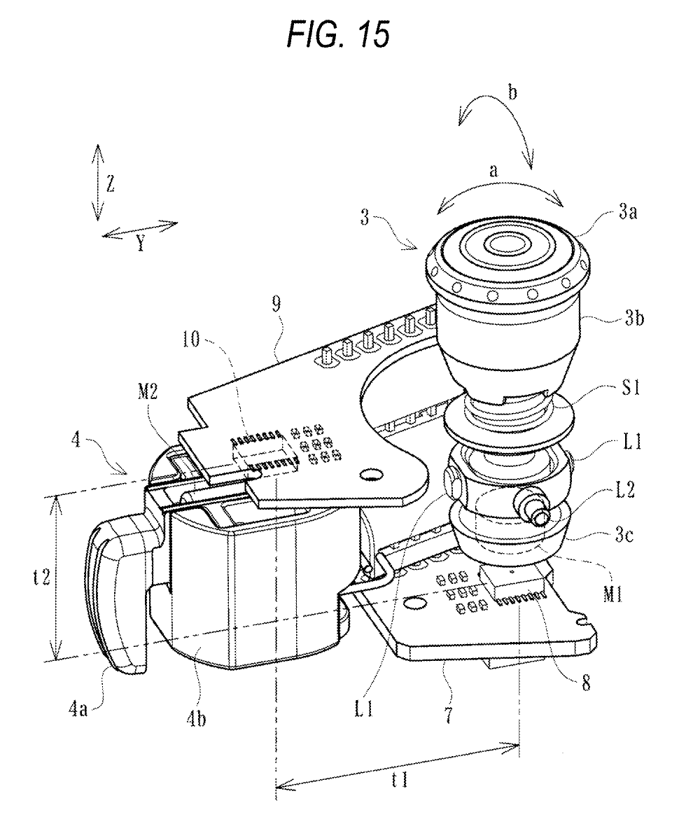

The first magnetic sensor 8 is attached to the inside of the body case 2 corresponding to the first operation unit 3, detects a magnetic change of the magnet M1 formed in the first operation unit 3 to detect an operation, and is arranged at a position facing the magnet M1 as shown in FIGS. 5, 15, and 16 (however, a predetermined portion of the case member 11 is interposed between the magnet M1 and the first magnetic sensor 8 as shown in FIGS. 3 and 5).

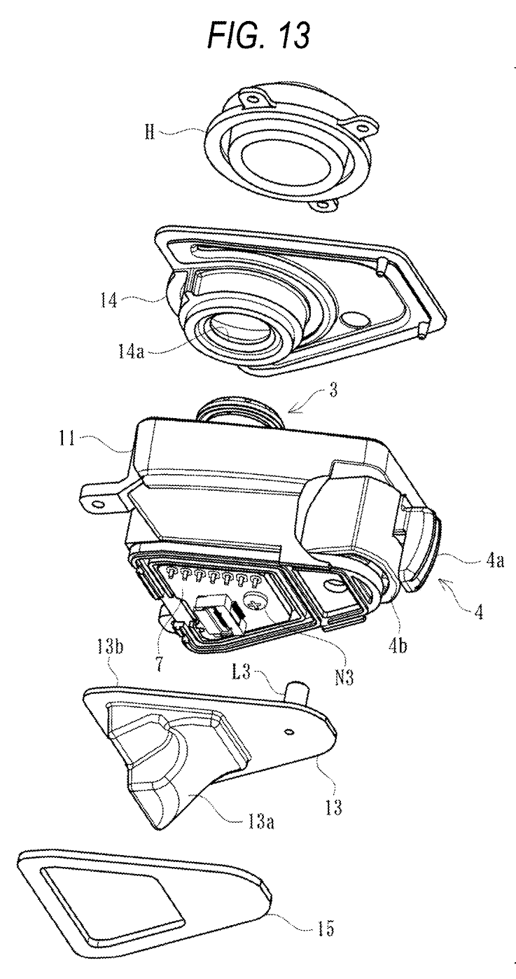

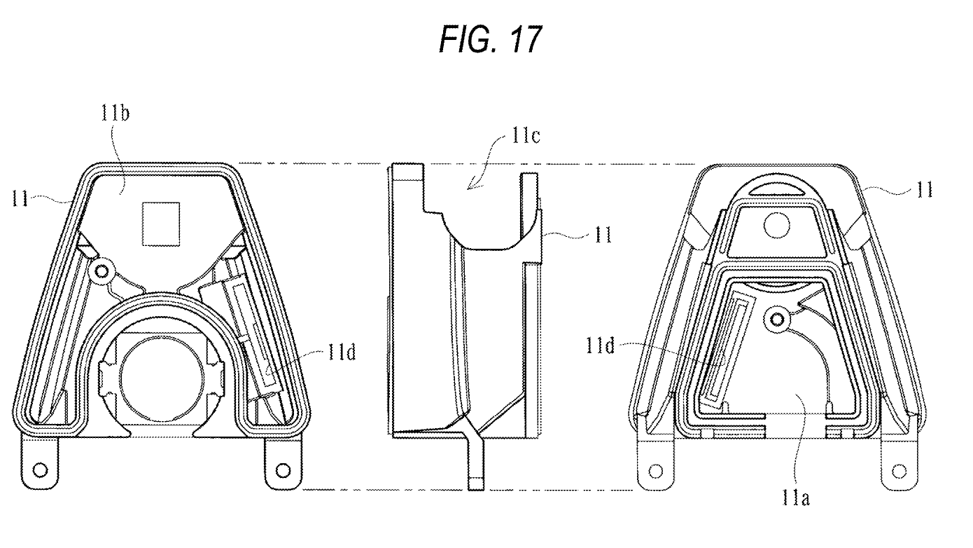

The first substrate 7 is formed of a printed substrate to which the first magnetic sensor 8 is attached, and as shown in FIG. 13, is fixed to one attachment surface 11a (see FIG. 17) of the case member 11 by an attachment screw N3. However, in the remote control device 1 according to the present embodiment, when the magnet M1 moves following the swinging operation of the first operation unit 3, the first magnetic sensor 8 can detect the magnetic change of the magnet M1 and output the detection signal to the outside via the electric circuit of the first substrate 7, so that the swinging operation of the first operation unit 3 can be detected.

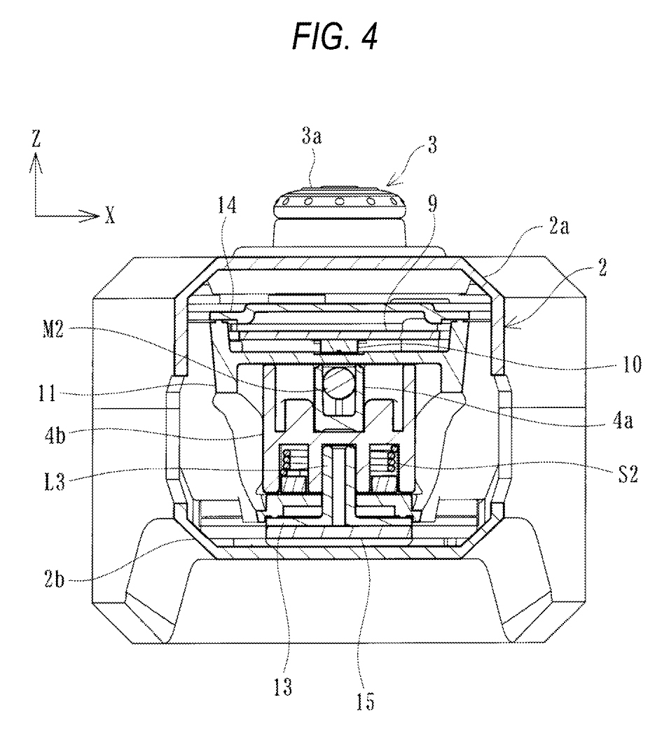

As shown in FIGS. 9A and 9B, the second operation unit 4 is positioned on the end surface of the tip end portion F1 of the body case 2, and as shown in FIG. 19, can be operated by the index finger of the operator holding the body case 2, and is formed of a member swingable about an axis L3 formed to protrude from the first accommodation case 13. Specifically, as illustrated in FIGS. 4, 7, and 8, the second operation unit 4 includes an operation portion 4a that can be operated by an operator touching the operation portion 4a with a finger, a swing case 4b in which a concave portion 4ba that accommodates the operation portion 4a is formed, and a return spring S2.

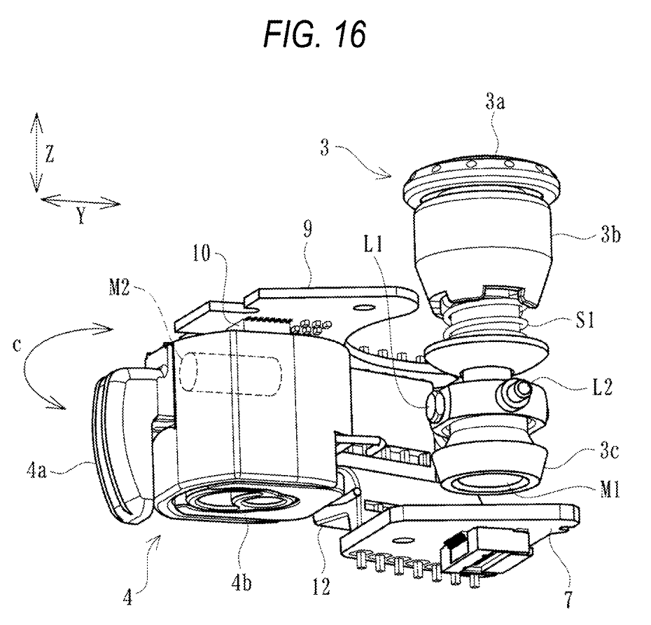

As shown in FIG. 16, when the operation portion 4a of the second operation unit 4 is operated in the c-direction (the width direction X of the remote control device 1), the operation portion 4a and the swing case 4b integrally swing about the axis L3 against the biasing force of the return spring S2. The second operation unit 4 may be configured such that the swing case 4b is provided with another return spring and the operation portion 4a can be pressed in a predetermined direction (the longitudinal direction Y of the remote control device 1) with respect to the swing case 4b.

A magnet M2 is attached to the operation portion 4a of the second operation unit 4. The magnet M2 has magnetic poles M2a and M2b (one is an S pole and the other is an N pole) different from each other with respect to the longitudinal direction Y of the remote control device 1 in a state where the second operation unit 4 is in the initial position, and is integrally attached to the second operation unit 4 and is configured to integrally move in accordance with the swing operation of the second operation unit 4.

The second magnetic sensor 10 is attached in the body case 2 corresponding to the second operation unit 4, detects a magnetic change of the magnet M2 formed in the second operation unit 4 to detect an operation, and is arranged at a position facing the magnet M2 as shown in FIGS. 4, 15, and 16 (however, a predetermined portion of the case member 11 is interposed between the magnet M2 and the second magnetic sensor 10 as shown in FIGS. 3 and 4).

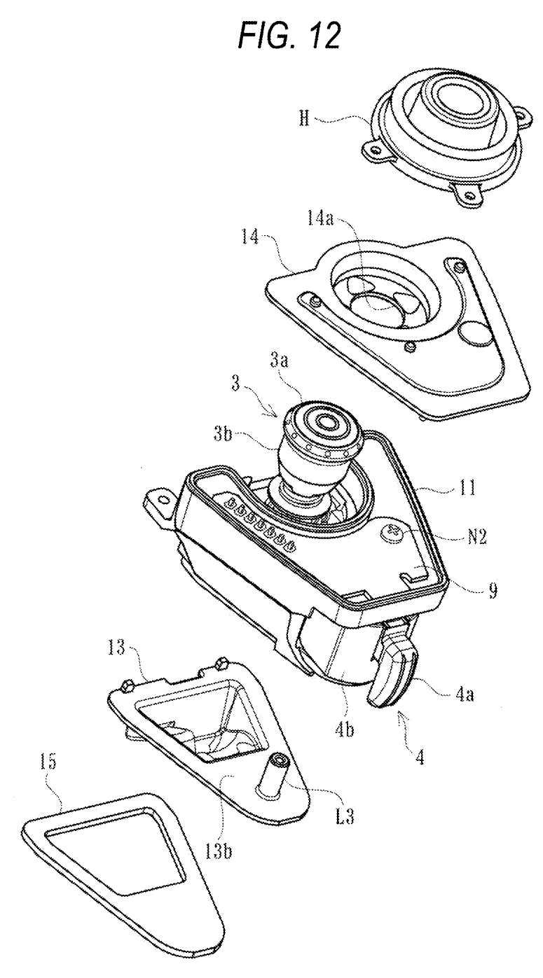

The second substrate 9 is formed of a printed substrate to which the second magnetic sensor 10 is attached, and is fixed to the other attachment surface 11b (see FIG. 17) of the case member 11 by an attachment screw N2 as illustrated in FIG. 12. However, in the remote control device 1 according to the present embodiment, when the magnet M2 moves following the swinging operation of the second operation unit 4, the second magnetic sensor 10 can detect the magnetic change of the magnet M2 and output the detection signal to the outside via the electric circuit of the second substrate 9, so that the swinging operation of the second operation unit 4 can be detected.

The case member 11 is made of a resin member attached in the body case 2, and as shown in FIG. 17, one attachment surface 11a, the other attachment surface 11b, an opening 11c, and a through hole 11d are formed. The one attachment surface 11a is a surface to which the first substrate 7 is attached as shown in FIG. 12, and the other attachment surface 11b is a surface to which the second substrate 9 is attached as shown in FIG. 13. Further, as shown in FIGS. 12 and 13, the opening 11c is formed of a portion into which the operation portion 4a and the swing case 4b of the second operation unit 4 are fitted, and swingably holds the second operation unit 4.

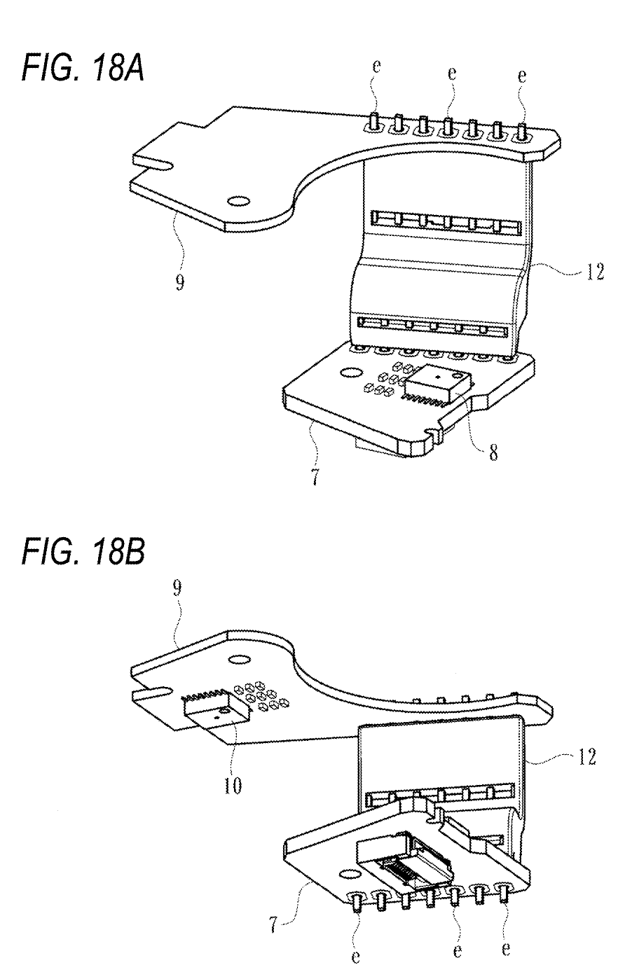

The through hole 11d is formed between the one attachment surface 11a and the other attachment surface 11b, and the connector member 12 can be inserted therethrough. The connector member 12 is formed of a connector in which a plurality of connection wirings e extend from one end portion to the other end portion, and as shown in FIGS. 18A and 18B, one end portion is connected to the first substrate 7 and the other end portion is connected to the second substrate 9, so that the electric circuits of the first substrate 7 and the second substrate 9 can be electrically connected.

That is, the connector member 12 is inserted into the through hole 11d to extend over the one attachment surface 11a and the other attachment surface 11b of the case member 11, and the first substrate 7 and the second substrate 9 can be electrically connected by connecting the connection wiring e to the first substrate 7 attached to the one attachment surface 11a and the second substrate 9 attached to the other attachment surface 11b.

Furthermore, the case member 11 according to the present embodiment is attached with an accommodation case (the first accommodation case 13 and the second accommodation case 14) that accommodates the first substrate 7 and the second substrate 9 and is filled with air. Specifically, as illustrated in FIGS. 9A, 9B, 12, and 13 the accommodation case attached to the case member 11 includes the first accommodation case 13 that covers the one attachment surface 11a and accommodates the first substrate 7, and the second accommodation case 14 that covers the other attachment surface 11b and accommodates the second substrate 9.

The first accommodation case 13 covers the one attachment surface 11a of the case member 11 and seals the attachment surface 11a together with air to waterproof and accommodate the first substrate 7, and a bulging portion 13a capable of accommodating a predetermined volume of air is formed to protrude. The second accommodation case 14 covers the other attachment surface 11b of the case member 11 and seals the attachment surface 11b together with air, thereby accommodating the second substrate 9 while waterproofing the second substrate 9, and has an opening portion 14a through which the first operation unit 3 can be inserted. The axis L3 for swinging the swing case 4b of the second operation unit 4 is integrally formed with the first accommodation case 13. In the remote control device 1 according to the present embodiment, a peripheral portion 13b of the first accommodation case 13 is sealed by a seal member 15, and the opening portion 14a of the second accommodation case 14 is sealed by the seal member H.

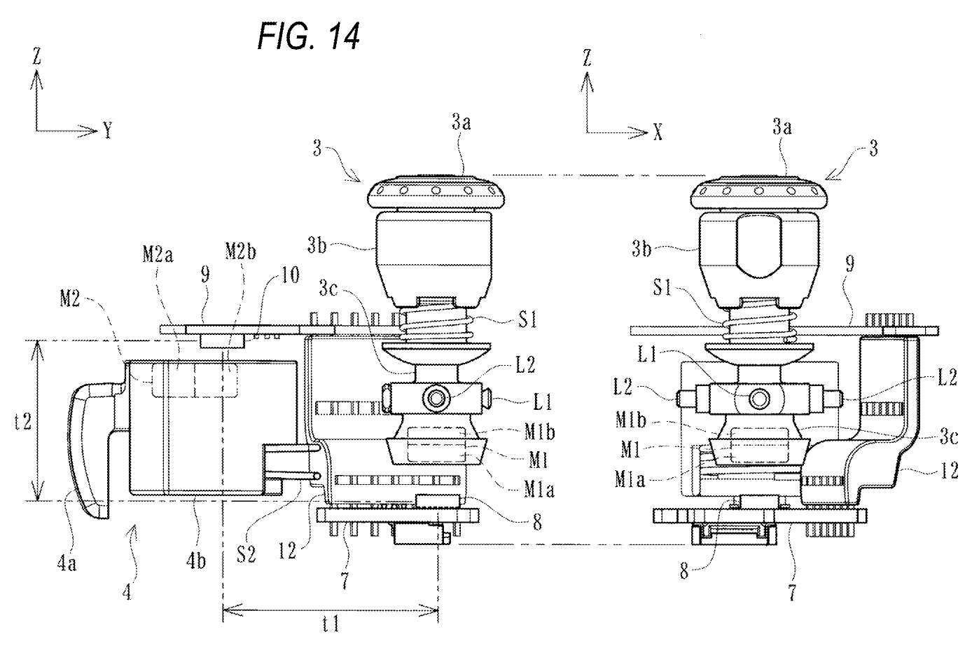

Here, in the remote control device 1 according to the present embodiment, the plurality of magnetic sensors (the first magnetic sensor 8 and the second magnetic sensor 10) attached to the substrates (the first substrate 7 and the second substrate 9) are arranged at positions different in level from each other in the body case 2. Specifically, as shown in FIGS. 3, 10, 14. and 15 the first magnetic sensor 8 attached to the first substrate 7 and the second magnetic sensor 10 attached to the second substrate 9 are arranged apart from each other by a predetermined dimension t1 with respect to the longitudinal direction Y of the remote control device 1 and apart from each other by a predetermined dimension t2 with respect to the thickness direction Z of the remote control device 1. As a result, they are arranged at positions different in level from each other within the body case 2.

In the remote control device 1 of the present embodiment, the magnets (M1, M2) formed in the operation units (the first operation unit 3 and the second operation unit 4) are attached to the first operation unit 3 and the second operation unit 4 such that the magnetic lines of the magnets (M1, M2) are in directions different from each other in the state where the first operation unit 3 and the second operation unit 4 are in the initial positions. Specifically, in the remote control device 1 of the present embodiment, when the first operation unit 3 and the second operation unit 4 are in the initial positions, the magnetic poles M1a and M1b of the magnet M1 are formed in the thickness direction Z of the remote control device 1, and the magnetic poles M2a and M2b of the magnet M2 are formed in the longitudinal direction Y of the remote control device 1, so that the direction of the magnetic line of the magnet M1 and the direction of the magnetic line of the magnet M2 are directions different from each other (in the present embodiment, orthogonal directions).

According to the remote control device 1 of the present embodiment, the remote control device 1 includes the body case 2, the plurality of operation units (the first operation unit 3 and the second operation unit 4), the plurality of magnetic sensors (the first magnetic sensor 8 and the second magnetic sensor 10), and the substrates (the first substrate 7 and the second substrate 9), and the plurality of magnetic sensors attached to the substrates are arranged at positions different in level from each other in the body case 2. Therefore, separate magnetic shielding members can be unnecessary or only small and lightweight magnetic shielding members can be required, the operability of the operation units can be maintained, and reduction in size and weight can be achieved while suppressing magnetic interference of the magnets (M1 and M2) formed in the operation units.

Further, according to the remote control device 1 of the present embodiment, the magnets (M1, M2) formed in the operation units (the first operation unit 3 and the second operation unit 4) are attached to the operation units such that the magnetic lines of force of the magnets (M1, M2) are in directions different from each other in the state where the operation units are in the initial positions. Therefore, it is possible to more reliably suppress the magnetic interference of the magnets formed in the operation units, and to further reduce the size and the weight of the remote control device 1.

Further, the substrate according to the present embodiment includes the first substrate 7 to which the first magnetic sensor 8 that detects the magnetic change of the magnet M1 formed in the first operation unit 3 and detects the operation of the first operation unit 3 is attached, and the second substrate 9 to which the second magnetic sensor 10 that detects the magnetic change of the magnet M2 formed in the second operation unit 4 and detects the operation of the second operation unit 4 is attached. Accordingly, in the substrate according to the present embodiment, the first magnetic sensor 8 and the second magnetic sensor 10 attached to the first substrate 7 and the second substrate 9 are arranged at positions different in level from each other in the body case 2. Therefore, it is possible to maintain the operability of the first operation unit 3 and the second operation unit 4, and to reduce the size and the weight while suppressing the magnetic interference of the magnets (M1 and M2) formed in the first operation unit 3 and the second operation unit 4.

Furthermore, according to the remote control device 1 of the present embodiment, the first substrate 7 is attached to the one attachment surface 11a of the case member 11, the second substrate 9 is attached to the other attachment surface 11b of the case member 11, and the first magnetic sensor 8 and the second magnetic sensor 10 of the first substrate 7 and the second substrate 9 attached to the case member 11 are different in level from each other. Therefore, the first magnetic sensor 8 of the first substrate 7 and the second magnetic sensor 10 of the second substrate 9 can be reliably arranged in different levels using the case member 11.

Further, the first operation unit 3 is positioned on the upper surface of the tip end portion of the body case 2, and the second operation unit 4 is positioned on the end surface of the tip end portion of the body case 2. Therefore, the second operation unit 4 can be operated with the index finger while the first operation unit 3 is operated with the thumb of the operator holding the body case 2, and the operability can be improved.

In particular, since the first operation unit 3 according to the present embodiment is the joystick having the operation levers (the first operation lever 3b and the second operation lever 3c) that can be swung in at least four directions orthogonal to each other from the initial position, the operation by the joystick can be easily performed. However, according to the remote control device 1 of the present embodiment, the vehicle to which the remote control device 1 is applied is a ship, and the outboard motor J of the ship can be operated by the operation unit (the first operation unit 3 and the second operation unit 4) under remote control. Therefore, the ship can be easily operated by the remote control device 1 under the remote control.

In addition, according to the remote control device 1 of the present embodiment, the remote control device 1 includes the body case 2, the plurality of operation units (the first operation unit 3 and the second operation unit 4), the plurality of magnetic sensors (the first magnetic sensor 8 and the second magnetic sensor 10), and the substrate (the first substrate 7 and the second substrate 9), and includes the accommodation case (the first accommodation case 13 and the second accommodation case 14) that accommodates the substrate and is filled with air. Therefore, it is possible to reduce the weight of the remote control device 1 and improve the operability of the operation units as compared with a case in which the substrate is filled with resin. In addition, since the remote control device 1 according to the present embodiment can obtain buoyancy by the air sealed in the accommodation case (the first accommodation case 13 and the second accommodation case 14), the remote control device 1 can float on the water surface and can be easily collected even when the remote control device 1 is accidentally dropped onto a river, the sea, or the like.

Further, the substrate according to the present embodiment includes the first substrate 7 to which the first magnetic sensor 8 that detects the magnetic change of the magnet M1 formed in the first operation unit 3 and detects the operation of the first operation unit 3 is attached, and the second substrate 9 to which the second magnetic sensor 10 that detects the magnetic change of the magnet M2 formed in the second operation unit 4 and detects the operation of the second operation unit 4 is attached, and the first substrate 7 and the second substrate 9 are respectively accommodated in the accommodation cases (the first accommodation case 13 and the second accommodation case 14). Therefore, it is possible to reduce the weight of the remote control device 1 and improve the operability of the first operation unit 3 and the second operation unit 4.

Furthermore, according to the remote control device 1 of the present embodiment, the first substrate 7 is attached to the one attachment surface 11a, the second substrate 9 is attached to the other attachment surface 11b, the case member 11 is provided, and the accommodation case includes the first accommodation case 13 that covers the one attachment surface 11a and accommodates the first substrate 7, and the second accommodation case 14 that covers the other attachment surface 11b and accommodates the second substrate 9, the weight of the remote control device 1 can be reduced while waterproofing the first substrate 7 and the second substrate 9 by the first accommodation case 13 and the second accommodation case 14.

In addition, according to the remote control device 1 of the present embodiment, the connector member 12 that extends over the one attachment surface 11a and the other attachment surface 11b of the case member 11 and electrically connects the first substrate 7 and the second substrate 9 is provided. Therefore, it is possible to accurately perform the electrical connection between the first substrate 7 and the second substrate 9 while waterproofing the first substrate 7 and the second substrate 9 by the first accommodation case 13 and the second accommodation case 14.

Although the embodiment according to the present disclosure has been described above, the present invention is not limited thereto. For example, the first magnetic sensor 8 and the second magnetic sensor 10 may be attached to the first substrate 7 and the second substrate 9, respectively, as in the present embodiment, or may be arranged at positions different in level from each other on one substrate. Further, three or more (a plurality of) substrates to which the magnetic sensors are attached may be provided, and in this case, the magnetic sensors attached to the respective substrates may be arranged at positions different in level from each other in the body case 2. In addition, the plurality of magnetic sensors may be arranged at different positions in level that are spaced apart from each other in the longitudinal direction Y and the thickness direction Z of the body case 2 as in the present embodiment, or may be arranged at different positions in level that are spaced apart from each other in the longitudinal direction Y and the width direction X, and the width direction X and the longitudinal direction Y, or may be arranged at positions on a plane including straight lines in a twisted positional relationship (positional relationship between two straight lines that are not parallel and do not intersect each other).

Further, the first operation unit 3 and the second operation unit 4 may be operation units of other forms, for example, a push-type switch knob (push switch knob) to which a magnet is attached, a slide-type switch knob (slide knob), or the like. Although the remote control device 1 according to the present embodiment operates the outboard motor J of a small ship under remote control, the remote control device 1 may be applied to other vehicles (such as an automobile, an ATV, a PWC, a snowmobile, a construction machine, and an agricultural machine).

The present invention may be applied to a remote control device having the same purpose, but with a different appearance shape or with other functions added thereto.

What is claimed is:

1. A remote control device for operating a vehicle by remote control, the remote control device comprising:
a body case configured to be gripped by an operator;
a plurality of operation units each configured to be operated at a predetermined position of the body case and formed with a magnet;
a plurality of magnetic sensors each corresponding to the respective operation unit, provided in the body case and configured to detect a magnetic change of the magnet formed in the operation unit to detect an operation; and
a substrate to which the magnetic sensors are attached, wherein
the magnetic sensors attached to the substrate are arranged at positions different in level from each other in the body case.

2. The remote control device according to claim 1, wherein
the magnets formed in the operation units are attached to the operation units such that magnetic lines of force of the magnets are in directions different from each other in a state where the operation units are in initial positions.

3. The remote control device according to claim 1, wherein
the operation unit includes a first operation unit and a second operation unit arranged at positions close to each other,
the substrate includes:
a first substrate to which a first magnetic sensor configured to detect a magnetic change of a magnet formed in the first operation unit to detect an operation of the first operation unit is attached; and
a second substrate to which a second magnetic sensor configured to detect a magnetic change of a magnet formed in the second operation unit to detect an operation of the second operation unit is attached, and
the first magnetic sensor and the second magnetic sensor attached to the first substrate and the second substrate are arranged at positions different in level from each other in the body case.

4. The remote control device according to claim 3, comprising:
a case member in which the first substrate is attached to one attachment surface of the case member, and the second substrate is attached to an other attachment surface of the case member, wherein
the first magnetic sensor and the second magnetic sensor on the first substrate and the second substrate attached to the case member are different in level from each other.

5. The remote control device according to claim 3, wherein
the first operation unit is positioned on an upper surface of a tip end portion of the body case, and the second operation unit is positioned on an end surface of the tip end portion of the body case.

6. The remote control device according to claim 5, wherein
the first operation unit is a joystick having an operation lever configured to be swung in at least four directions orthogonal to each other from an initial position.

7. The remote control device according to claim 1, wherein
the vehicle is a ship, and an outboard motor of the ship is configured to be operated by the operation unit under remote control.
